(19) United States
(12) Patent Application Publication
(10) Pub. No.: US 2012/0220708 A1
(43) Pub. Date: Aug. 30, 2012

(54) POLYCARBONATE RESIN COMPOSITION, POLYCARBONATE RESIN MOLDED ARTICLE, AND MANUFACTURING METHOD THEREFOR

(75) Inventor: Takayoshi Tanaka, Chiba (JP)

(73) Assignee: IDEMITSU KOSAN CO., LTD., Tokyo (JP)

(21) Appl. No.: 13/504,679

(22) PCT Filed: Oct. 29, 2010
(86) PCT No.: PCT/JP2010/069334

§ 371 Date: Apr. 27, 2012

(30) Foreign Application Priority Data
Oct. 30, 2009 (JP) 2009-250996

(51) Int. Cl. C08L 69/00; C08K 3/08; B29C 45/72; C08K 3/40

(52) U.S. Cl. 524/441; 524/494; 264/328.16

(57) ABSTRACT

Provided are a polycarbonate resin composition including, with respect to 100 parts by mass of (A) an aromatic polycarbonate resin, 0.05 to 0.3 part by mass of (B) titanium oxide having an average particle diameter of 0.05 to 6 μm, and (C) 0.005 to 1 part by mass of (C-1) glossy particles having an average particle diameter of 10 μm or more and less than 60 μm, and 0.005 to 2.5 parts by mass of (C-2) glossy particles having an average particle diameter of 60 to 300 μm, a polycarbonate resin molded article obtained by molding the resin composition, and a method of producing a polycarbonate resin molded article characterized by including subjecting the resin composition to injection molding at a mold temperature of 120° C. or more. The polycarbonate resin composition of the present invention is capable of providing a molded article having reduced visibility of a weld line fusion portion, no visible difference in luminosity between the left and right sides of a weld line, and a good metallic or galactic appearance, and is excellent in heat resistance and mechanical properties.

### TECHNICAL FIELD

The present invention relates to a polycarbonate resin composition, a polycarbonate resin molded article using the composition, and a method of producing the resin molded article, more specifically, to a polycarbonate resin composition suitable for a structural member field where a design appearance is requested such as a television, refrigerator, or cleaner having, for example, a metallic appearance or a galactic appearance while taking advantage of the heat resistance and mechanical properties of a polycarbonate, a polycarbonate resin molded article obtained by molding the resin composition, and a method of producing the resin molded article.

### BACKGROUND ART

Polycarbonate resin molded articles have been widely used as, for example, industrial transparent materials in the fields of electrical and electronic engineering, mechanical engineering, automobiles, and the like or optical materials for lenses, optical disks, and the like because each of the articles is excellent in transparency, heat resistance, and mechanical properties.

In addition, it has been known that glossy particles and the like are added when a high degree of design appearance such as a metallic appearance or a galactic appearance (such an appearance that the entirety sparkles like the night sky studded with stars) is needed.

However, when a polycarbonate resin composition to which the glossy particles have been added is subjected to resin molding, a weld line occurs at a portion where molten resins merge with each other to be welded. Accordingly, a fusion line, and a difference in luminosity between the left and right sides with respect to the fusion line (the orientations of the glossy particles) occur. As a result, the value of the molded article as a commercial product drastically reduces.

For example, (1) a resin composition containing, as glossy particles, particles having an average particle diameter of 10 to 300 μm and each having a shape with an aspect ratio of 1/8 to 1 (see Patent Literature 1) and (2) a resin composition containing, as glossy particles, metal fine particles each of which is a quadrangle and is provided with a notch in one of its corners (see Patent Literature 2) have each been proposed as a polycarbonate resin composition which contains glossy particles and in which an investigation has been conducted on the prevention of the formation of a weld line.

However, a sufficiently satisfactory composition cannot be obtained in reliance only on the shapes of the glossy particles themselves like Patent Literatures 1 and 2 from the viewpoint of not only, of course, the suppression of the occurrence of the weld line but also the reduction of the difference in luminosity between the left and right sides with respect to the weld line.

### PATENT LITERATURE

[PTL 1] JP 06-99594 A

[PTL 2] JP 07-53768 A

### SUMMARY OF INVENTION

### Problems to Be Solved by the Invention

An object of the present invention is to provide a polycarbonate resin composition capable of providing a molded article having reduced visibility of a weld line fusion portion, no visible difference in luminosity between the left and right sides of a weld line, and a good metallic or galactic appearance, the composition being excellent in heat resistance and mechanical properties, a polycarbonate resin molded article obtained by molding the resin composition, and a method of producing the resin molded article.

### Solution to Problem

The inventors of the present invention have made extensive studies, and as a result, have found that the object can be achieved with a polycarbonate resin composition obtained by incorporating, into an aromatic polycarbonate resin, titanium oxide having a specific average particle diameter and two kinds of glossy particles having different particle diameter ranges each at a predetermined ratio, a polycarbonate resin molded article obtained by molding the resin composition, and a method of producing the resin molded article. The present invention has been completed on the basis of such finding.

That is, the present invention provides the following polycarbonate resin composition, a polycarbonate resin molded article obtained by molding the resin composition, and a method of producing the resin molded article.

1. A polycarbonate resin composition, comprising, with respect to 100 parts by mass of (A) an aromatic polycarbonate resin, 0.05 to 0.3 part by mass of (B) titanium oxide having an average particle diameter of 0.05 to 6 μm, and (C) 0.005 to 1 part by mass of (C-1) glossy particles having an average particle diameter of 10 μm or more and less than 60 μm, and 0.005 to 2.5 parts by mass of (C-2) glossy particles having an average particle diameter of 60 to 300 μm.

2. The polycarbonate resin composition according to the item 1, further comprising 0.05 to 0.5 part by mass of (D) silicone particles having an average particle diameter of 0.05 to 6 μm with respect to 100 parts by mass of the component (A).

3. The polycarbonate resin composition according to the item 1 or 2, wherein the glossy particles as the component (C) comprise one kind or two or more kinds selected from the group consisting of mica, metal particles, metal sulfide particles, particles each having a surface coated with a metal or a metal oxide, and glass flakes each having a surface coated with a metal or a metal oxide.

4. The polycarbonate resin composition according to any one of the items 1 to 3, further comprising 0.0001 to 0.3 part by mass of (E) a colorant with respect to 100 parts by mass of the component (A).

5. The polycarbonate resin composition according to the item 4, wherein the colorant as the component (E) comprises aluminum powder particles.

6. The polycarbonate resin composition according to the item 5, wherein the aluminum powder particles have an average particle diameter of 30 to 80 μm.

7. A polycarbonate resin molded article obtained by molding the polycarbonate resin composition according to any one of the items 1 to 6.

8. The polycarbonate resin molded article according to the item 7, wherein the polycarbonate resin molded article is obtained by injection molding at a mold temperature of 120° C. or more.

9. A method of producing a polycarbonate resin molded article, comprising subjecting the polycarbonate resin composition according to any one of the items 1 to 6 to injection molding at a mold temperature of 120° C. or more.

### ADVANTAGEOUS EFFECTS OF INVENTION

According to the present invention, there are provided a polycarbonate resin composition having excellent heat resistance and excellent mechanical properties, a polycarbonate resin molded article obtained by using the resin composition, the molded article having reduced visibility of a weld line fusion portion, no visible difference in luminosity between the left and right sides of a weld line, and an excellent metallic or galactic appearance, and a production method by which the molded article can be obtained.

### Description of Embodiments

[Polycarbonate Resin Composition]

A polycarbonate resin composition of the present invention contains, as essential components, (A) an aromatic polycarbonate resin, (B) titanium oxide having an average particle diameter of 0.05 to 6 μm, and (C) glossy particles including (C-1) glossy particles having an average particle diameter of 10 μm or more and less than 60 μm, and (C-2) glossy particles having an average particle diameter of 60 to 300 μm.

((A) Aromatic Polycarbonate Resin)

In the polycarbonate resin composition of the present invention, an aromatic polycarbonate resin produced by a reaction between a dihydric phenol and a carbonate precursor can be specifically used as the aromatic polycarbonate resin as the component (A).

A method of producing the aromatic polycarbonate resin as the component (A) is not particularly limited, and resins produced by various conventional methods can each be used as the resin. For example, a resin produced from a dihydric phenol and a carbonate precursor by a solution method (interfacial polycondensation method) or a melt method (ester exchange method), that is, a resin produced by, for example, an interfacial polycondensation method involving causing the dihydric phenol and phosgene to react with each other in the presence of a terminal stopper or an ester exchange method involving causing the dihydric phenol and diphenyl carbonate or the like to react with each other in the presence of a terminal stopper can be used.

As the dihydric phenol, various examples are given. In particular, examples thereof include 2,2-bis(4-hydroxyphenyl)propane (bisphenol A), bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkane, bis(4-hydroxyphenyl)oxide, bis(4-hydroxyphenyl)sulfide, bis(4-hydroxyphenyl)sulfone, bis(4-hydroxyphenyl)sulfoxide, and bis(4-hydroxyphenyl)ketone. In addition, hydroquinone, resorcin, and catechol can be also exemplified. One kind of those dihydric phenols may be used alone, or two or more kinds thereof maybe used in combination. Of those, bis(hydroxyphenyl)alkanes are preferred, and bisphenol A is particularly preferred.

On the other hand, as the carbonate precursor, a carbonyl halide, a carbonyl ester, or a haloformate, and the like are given. Specifically, phosgene, a dihaloformate of a dihydric phenol, diphenyl carbonate, dimethyl carbonate, and diethyl carbonate are given.

It should be noted that the aromatic polycarbonate resin may have a branched structure. As a branching agent, 1,1,1-tris(4-hydroxyphenyl)ethane, α,α′,α″-tris(4-hydroxyphenyl)-1,3,5-triisopropylbenzene, phloroglucin, trimellitic acid, and isatin bis(o-cresol) are exemplified.

In the present invention, a viscosity-average molecular weight (Mv) of the component (A) is generally 10,000 to 50,000, preferably 13,000 to 35,000, more preferably 15,000 to 20,000.

The viscosity-average molecular weight (Mv) is calculated by the following equation, after a limiting viscosity [η] is obtained by determining a viscosity of a methylene chloride solution at 20° C. by using a Ubbelohde type viscometer.

[η]=1.23×10⁻⁵ Mv^{0.83}

A molecular terminal group in (A) the aromatic polycarbonate resin is not particularly limited, and a monovalent, phenol-derived group as a conventionally known terminal stopper may be used; a monovalent, phenol-derived group having an alkyl group having 10 to 35 carbon atoms is preferred. When the molecular terminal is a phenol-derived group having an alkyl group having 10 or more carbon atoms, a polycarbonate resin composition to be obtained has good flowability. In addition, when the molecular terminal is a phenol-derived group having an alkyl group having 35 or less carbon atoms, the polycarbonate resin composition to be obtained has good heat resistance and good impact resistance.

Examples of the monovalent phenol having an alkyl group having 10 to 35 carbon atoms include decyl phenol, undecyl phenol, dodecyl phenol, tridecyl phenol, tetradecyl phenol, pentadecyl phenol, hexadecyl phenol, heptadecyl phenol, octadecyl phenol, nonadecyl phenol, icosyl phenol, docosyl phenol, tetracosyl phenol, hexacosyl phenol, octacosyl phenol, triacontyl phenol, dotriacontyl phenol, and pentatriacontyl phenol.

The alkyl group may be present at any one of the o-, m-, and p-positions of each of those alkyl phenols with respect to the hydroxy group; the alkyl group is preferably present at the p-position. In addition, the alkyl group may be a linear group, a branched group, or a mixture of them.

At least one substituent of each of the alkyl phenols has only to be the alkyl group having 10 to 35 carbon atoms, and the other four substituents are not particularly limited; each of the other four substituents maybe an alkyl group having 1 to 9 carbon atoms, an aryl group having 6 to 20 carbon atoms, or a halogen atom, or each of the alkyl phenols may be unsubstituted except for the hydroxy group and the alkyl group having 10 to 35 carbon atoms.

Only one of the terminals of the polycarbonate resin may be sealed with a monovalent phenol having the alkyl group having 10 to 35 carbon atoms, or each of both the terminals may be sealed with the phenol. In addition, terminals each denatured with the phenol account for preferably 20% or more, more preferably 50% or more of all terminals from the viewpoint of an improvement in flowability of the polycarbonate resin composition to be obtained. That is, the other terminals none of which is sealed with the phenol may each be sealed with a hydroxy group terminal or any one of the other terminal stoppers in the following description.

Here, examples of the other terminal stoppers include phenol, p-cresol, p-tert-butylphenol, p-tert-octylphenol, p-cumylphenol, p-nonylphenol, p-tert-amylphenol, bromophenol, tribromophenol, and pentabromophenol, which are commonly used in the production of the aromatic polycarbonate resin. Of those, a halogen-free compound is preferred in view of environmental issues.

In the polycarbonate resin composition of the present invention, the aromatic polycarbonate resin as the component (A) can appropriately contain, in addition to the polycarbonate resin, a copolymer resin such as a polyester-polycarbonate resin obtained by polymerizing polycarbonate in the presence of an ester precursor such as a bifunctional carboxylic acid such as terephthalic acid or an ester-forming derivative of the acid, or any other polycarbonate resin to such an extent that the object of the present invention is not impaired.

((B) Titanium Oxide)

In the present invention, the average particle diameter of titanium oxide as the component (B) is 0.05 to 6 μm. When the average particle diameter is less than 0.05 μm, a weld line becomes easily visible and hence a visibility-reducing effect cannot be obtained. When the average particle diameter exceeds 6 μm, the component is poor in dispersibility in the resin composition. A preferred average particle diameter is 0.1 to 0.5 μm.

The component (B) to be used in the present invention is typically used in the form of a fine powder. Although the component may be of any one of a rutile type and an anatase type, the component is preferably of a rutile type in terms of, for example, heat stability and weatherability. In addition, the shapes of the fine powder particles are not particularly limited, and a flaky shape, a spherical shape, an amorphous shape, or the like can be appropriately selected and used.

In addition, titanium oxide to be used as the component (B) may be subjected to a surface treatment with an amine compound, a polyol compound, or the like as well as a water-containing oxide of aluminum and/or silicon. Performing the treatment improves uniform dispersibility in the polycarbonate resin composition and the stability of the dispersed state, thereby enabling the production of a uniform composition. An alumina hydrated compound, a silica hydrated compound, triethanolamine, and trimethylolethane can be given as examples of the water-containing oxides of aluminum and silica, the amine compound, and the polyol compound, respectively. A treatment method itself in the surface treatment is not particularly limited and an arbitrary method is appropriately adopted. Although the amount of a surface treatment agent to be provided for the surfaces of the titanium oxide particles by the treatment is not particularly limited, a proper amount is typically about 0.1 to 10.0 mass % with respect to titanium oxide in consideration of the moldability of the resin composition.

The content of the component (B) is 0.05 to 0.3 part by mass, preferably 0.1 to 0.2 part by mass with respect to 100 parts by mass of the component (A). When the content is less than 0.05 part by mass, a weld line becomes easily visible and hence the visibility-reducing effect cannot be obtained. On the other hand, when the content exceeds 0.3 part by mass, a metallic feeling is lost. The visibility of the weld line can be alleviated by incorporating a large amount of large titanium oxide particles. On the other hand, however, the metallic feeling of a molded article is impaired. Accordingly, the content of the glossy particles needs to be increased. As a result, however, a difference in luminosity between the left and right sides with respect to the weld line enlarges.

((C) Glossy Particles)

Examples of the glossy particles as the component (C) in the present invention include mica, metal particles, metal sulfide particles, particles each having a surface coated with a metal or a metal oxide, and glass flakes each having a surface coated with a metal or a metal oxide. Those may be used alone, or two or more kinds thereof may be used in combination.

Specific examples of the metal particles include metal powders each made of, for example, aluminum, gold, silver, copper, nickel, titanium, or stainless steel. Specific examples of the particles each having a surface coated with a metal or a metal oxide include metal oxide coated mica-based particles such as mica titanium coated with titanium oxide and mica coated with bismuth trichloride. Specific examples of the metal sulfide particles include metal sulfide powders each made of, for example, nickel sulfide, cobalt sulfide, or manganese sulfide. A metal used in each of the glass flakes each having a surface coated with a metal or a metal oxide is, for example, gold, silver, platinum, palladium, nickel, copper, chromium, tin, titanium, or silicon.

Here, glossy particles having a small average particle diameter generally have such properties that the particles each have an inconspicuous orientation but each provide poor metallic feeling. In contrast, glossy particles having a large average particle diameter have such properties that the particles each provide excellent metallic feeling but each have a conspicuous orientation. In addition, quality drawbacks such as the occurrence of the weld line of the resin molded article, and the difference in luminosity between the left and right sides with respect thereto arise depending on the sizes and content of the glossy particles. Accordingly, it is important to select the sizes of the glossy particles to be used and specify the contents of these particles. That is, when as described below, two kinds of different average particle diameter ranges of the component (C-1) and the component (C-2) are specified for the glossy particles, and these two kinds of glossy particles are used in combination so that their contents may take specific values, a metallic feeling is imparted and the orientations of the glossy particles themselves are reduced. In addition, the occurrence of a weld line, and the difference in luminosity between the left and right sides with respect thereto can be reduced.

The average particle diameter of the glossy particles as the component (C-1) is 10 μm or more and less than 60 μm, and the average particle diameter of the glossy particles as the component (C-2) is 60 μm to 300 μm.

The average particle diameter of the glossy particles can be determined from the result of a particle size distribution measured for a kerosene-based solution containing the glossy particles at a concentration of 0.1 mass% with, for example, a laser diffraction particle size distribution-measuring apparatus (MASTER SIZER 2000 manufactured by Malvern Instruments Ltd.).

The content of the component (C-1) is 0.005 to 1 part by mass, preferably 0.01 to 0.1 part by mass with respect to 100 parts by mass of the component (A). The content of the component (C-2) is 0.005 to 2.5 parts by mass, preferably 0.05 to 2 parts by mass with respect to 100 parts by mass of the component (A). When the contents of the component (C-1) or the component (C-2) are less than 0.005 part by mass, a galactic appearance or a metallic appearance is not formed, and hence the occurrence of a weld line, and the difference in luminosity between the left and right sides with respect thereto cannot be reduced. In addition, when the content of the component (C-1) exceeds 1 part by mass or the content of the component (C-2) exceeds 2.5 parts by mass, the amount in which the glossy particles themselves float on the surface of a molded product increases to impair its appearance. In addition, a weld line is formed, and the difference in luminosity between the left and right sides with respect thereto is apt to occur.

((D) Silicone Particles)

In the polycarbonate resin composition of the present invention, silicone particles having an average particle diameter of 0.05 to 6 μm can be incorporated as a component (D). As long as the average particle diameter falls within the range, the reducing effect on the visibility of a weld line can be obtained. The average particle diameter of the silicone particles is preferably 0.05 to 0.4 μm.

The component (D), which is not particularly limited as long as the component is silicone particles having an average particle diameter within the range, is preferably a reactive functional group-containing silicone compound. Examples of the reactive functional group-containing silicone compound include polyorganosiloxane polymers and/or copolymers each having a basic structure represented by a general formula (1):

R¹ₐR²_{b}SiO_{(4-a-b)/2} (1)

In the general formula (1), R¹ represents a reactive functional group. Examples of the reactive functional group include an alkoxy group, an aryloxy group, a polyoxyalkylene group, a hydrogen group, a hydroxy group, a carboxy group, a silanol group, an amino group, a marcapto group, an epoxy group, and a vinyl group. Of those, preferred are the alkoxy group, the hydroxy group, the hydrogen group, the epoxy group, and the vinyl group.

R² represents a hydrocarbon group having 1 to 12 carbon atoms. Examples of the hydrocarbon group include a linear or branched alkyl group having 1 to 12 carbon atoms, a cycloalkyl group having 5 to 12 carbon atoms, an aryl group having 6 to 12 carbon atoms, and an aralkyl group having 7 to 12 carbon atoms. Specific examples thereof include a methyl group, an ethyl group, an n-propyl group, an isopropyl group, various butyl groups, various pentyl groups, various hexyl groups, various octyl groups, a cyclopentyl group, a cyclohexyl group, a phenyl group, a tolyl group, a xylyl group, a benzyl group, and a phenetyl group.

a and b represent numbers satisfying relationships of 0<a≦3, 0<b≦3, and 0<a+b≦3. When multiple R¹'s are present, the multiple R¹'s may be the same or different from one another. When multiple R²'s are present, the multiple R²'s may be the same or different from one another.

As the component (D), polyorganosiloxane polymer and/or copolymer resins each having multiple reactive functional groups of the same kind, and polyorganosiloxane polymers and/or copolymers each having multiple reactive functional groups of different kinds can be used in combination.

The polyorganosiloxane polymers and/or copolymers each having the basic structure represented by the general formula (1) each have a ratio of the number of its reactive functional groups (R¹) to the number of its hydrocarbon groups (R²) of typically about 0.1 to 3, preferably about 0.3 to 2.

In addition, the silicone particles as the component (D) preferably have good dispersibility in melt kneading. A liquid component having a viscosity at room temperature of about 10 to 500,000 mm²/s can be given as an example of the component. Such component has the following feature. Even when the component (D) is a liquid, the component is uniformly dispersed in the composition, and rarely bleeds at the time of its molding or to the surface of the molded article.

The content of the component (D) is preferably 0.05 to 0.5 part by mass, more preferably 0.1 to 0.4 part by mass with respect to 100 parts by mass of the component (A). As long as the content falls within the range of 0.05 to 0.5 part by mass, the reducing effect on the visibility of a weld line can be obtained and the metallic feeling is not impaired. The visibility of the weld line can be alleviated by incorporating a large amount of large particles as the component (D) as in the case of (B) titanium oxide. On the other hand, however, the metallic feeling of the molded article is impaired. Accordingly, the content of the glossy particles needs to be increased. As a result, however, the difference in luminosity between the left and right sides with respect to the weld line enlarges.

((E) Colorant)

In the present invention, a colorant as a component (E) can be incorporated when a colored molded article is desired.

The colorant as the component (E) to be used varies depending on a desired color. For example, in order that a silver metallic base color may be expressed, aluminum powder particles are preferably used. When the aluminum powder particles are used for expressing the silver metallic tone, particles each having a proper size need to be selected because the particles serve in the same manner as in the glossy particles. An excessively large size is apt to be responsible for the occurrence of a gel. Accordingly, the average particle diameter of the aluminum powder particles is preferably about 30 to 80 μm.

The content of the component (E), which has only to be appropriately adjusted depending on the hue of the molded article, is preferably 0.0001 to 0.3 part by mass, more preferably 0.05 to 0.3 part by mass with respect to 100 parts by mass of the component (A) in ordinary cases. For example, when the aluminum powder particles are used, as long as the content is 0.0001 part by mass or more, the case where the content is so small that the molded article looks white can be avoided. As long as the content is 0.3 part by mass or less, the case where the content is so large that the molded article looks dark gray can be avoided. As long as the content falls within the range of about 0.0001 to 0.3 part by mass, a desired silver metallic tone can be obtained in ordinary cases.

Further, examples of the colorant which may be used as the component (E) other than the aluminum powder particles include a methine-based dye, a pyrazolone-based dye, a perinone-based dye, an azo-based dye, a quinophthalone-based dye, and an anthraquinone-based dye. Of those, from the viewpoint of, for example, heat resistance and durability of the composition, anthraquinone-based orange dyes and green dyes can be preferably used alone or in a mixture of them.

(Other Additives)

In addition to the components (A) to (E), a release agent, a stabilizer (antioxidant), a UV absorber, an antistatic agent, a fluorescent bleach, and the like can be appropriately incorporated into the polycarbonate resin composition of the present invention as required to such an extent that the object of the present invention is not impaired.

A higher fatty acid ester of a monohydric or polyhydric alcohol may be exemplified as the release agent which may be added where required. Such higher fatty acid ester is preferably a partial or complete ester of a monohydric or polyhydric alcohol having 1 to 20 carbon atoms and a saturated fatty acid having 10 to 30 carbon atoms. Examples of the partial or complete ester of a monohydric or polyhydric alcohol and a saturated fatty acid include monoglyceride stearate, monosorbitate stearate, monoglyceride behenate, pentaerythritol monostearate, pentaerythritol tetrastearate, propyleneglycol monostearate, stearyl stearate, palmityl palmitate, butyl stearate, methyl laurate, isopropyl palmitate, and 2-ethylhexyl stearate. Of those, monoglyceride stearate and pentaerythritol tetrastearate are preferably used.

One kind of those release agents may be used alone, or two or more kinds of them may be used in combination. Such release agent is typically added in an amount of about 0.1 to 5.0 parts by mass with respect to 100 parts by mass of the component (A).

As a stabilizer (antioxidant) which may be added where required, phenol-based antioxidants and phosphorous-based antioxidants are exemplified.

Examples of the phenol -based antioxidants include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamid e), 3,5-di-tert-butyl-4-hydroxy-benzylphophonate diethyl ester, tris(3,5-di-tert-butyl-4-hydroxybenzyl)isocyanurate, and 3,9-bis[1,1-dimethyl-2-[β-(3-tert-butyl-4-hydroxy-5-methylphenyl)propionyloxy]ethyl]-2,4,8,10-tetraoxaspiro(5,5)undecane.

Examples of the phosphorous-based antioxidants include triphenyl phosphite, trisnonylphenyl phosphite, tris(2,4-di-tert-butylphenyl)phosphite, tridecyl phosphite, trioctyl phopshite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerythritol diphosphite, bis(2,4-di-tert-butylphenyl)pentaerythritol diphosphite, and distearyl pentaerythritol diphosphite.

One kind of those antioxidants may be used alone, or two or more kinds of them may be used in combination. Such antioxidant is typically added in an amount of about 0.05 to 1.0 part by mass with respect to 100 parts by mass of the component (A).

As the UV absorber, a benzotriazole-based UV absorber, a triazine-based UV absorber, a benzoxazine-based UV absorber, a benzophenone-based UV absorber, or the like may be used.

Examples of the benzotriazole-based UV absorber include 2-(2′-hydroxy-5′-methylphenyl)benzotriazole, 2-(2′-hydroxy-3′-(3,4,5,6-tetrahydrophthalimidomethyl)-5′-methylphenyl)benzotriazole, 2-(2′-hydroxy-3′,5′-di-tert-butylphenyl)benzotriazole, 2-(2′-hydroxy-5′-tert-octylphenyl)benzotriazole, 2-(3′-tert-butyl-5′-methyl-2′-hydroxyphenyl)-5-chlorobenzotriazole, 2,2′-methylenebis(4-(1,1,3,3-tetramethylbutyl)-6-(2H-benzotriazol-2-yl)phenol), 2-(2′-hydroxy-3′5′-bis(α,αdimethylbenzyl)phenyl)-2H-benzotriazole, 2-(3′,5′-di-tert-amyl-2′-hydroxyphenyl)benzotriazole, and 5-trifluoromethyl-2-(2-hydroxy-3-(4-methoxy-u-cumyl)-5-tert-butylphenyl)-2H-benzotriazole. Of those, 2-(2′-hydroxy-5′-tert-octylphenyl)benzotriazole is preferred.

As the triazine-based UV absorber, for example, TINUVIN 400 (trade name) (manufactured by Ciba Specialty Chemicals Inc.) which is a hydroxyphenyltriazine-based UV absorber is preferred.

Examples of the benzoxazine-based UV absorber include 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2,2′-bis(3,1-benzoxazin-4-one), 2,2′-p-phenylenebis(3,1-benzoxazin-4-one), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), and 1,3,5-tris(3,1-benzoxazin-4-one-2-yl)benzene. Of those, 2,2′-p-phenylenebis(3,1-benzoxazin-4-one) is preferred.

Examples of the benzophenone-based UV absorber include 2-hydroxy-4-methoxybenzophenone, 2-hydroxy-4-n-octoxybenzophenone, 2-hydroxy-4-methoxy-2′-carboxybenzophenone, 2,4-dihydroxybenzophenone, and 2,2′-dihydroxy-4-methoxybenzophenone. Of those, 2-hydroxy-4-n-octoxybenzophenone is preferred.

One kind of those UV absorbers may be used alone, or two or more kinds of them may be used in combination. Such UV absorber is typically added in an amount of about 0.05 to 2.0 parts by mass with respect to 100 parts by mass of the component (A).

As the antistatic agent, for example, a monoglyceride of the fatty acid having 14 to 30 carbon atoms, and more specifically, monoglyceride stearate, monoglyceride palmitate, or a polyamide polyether block copolymer may be used.

As the fluorescent bleach, for example, stilbene-based, benzoimidazole-based, naphthalimide-based, rhodamine-based, coumarin-based, and oxazine-based compounds are exemplified. More specifically, commercially-available products such as UVITEX (trade name, manufactured by Ciba Specialty Chemicals Inc.), OB-1 (trade name, manufactured by Eastman Chemical Company), TBO (trade name, manufactured by SUMITOMO SEIKA CHEMICALS CO., LTD.), Kaycoll (trade name, manufactured by NIPPON SODA CO., LTD.), Kayalight (trade name, manufactured by NIPPON KAYAKU CO., LTD.), and Leucophor EGM (trade name, manufactured by Clariant Japan) may be used.

(Preparation Method)

A method of preparing the polycarbonate resin composition of the present invention is not particularly limited, and a conventionally known method can be adopted. To be specific, the composition can be prepared by: blending the components (A) to (E), and, as required, other additives each at a predetermined ratio; and kneading the mixture.

The blending and the kneading are performed by preliminarily mixing the compounds using commonly used devices such as a ribbon blender and a drum tumbler, and using a Henschel mixer, a Banbury mixer, a single-screw extruder, a twin-screw extruder, a multi-screw extruder, and a cokneader. Heating temperature in kneading is appropriately selected generally from a range of about 240 to 300° C.

It should be noted that any component to be incorporated other than the aromatic polycarbonate resin can be melted and kneaded with part of the aromatic polycarbonate resin in advance before being added: the component can be added as a master batch.

[Polycarbonate Resin Molded Article and Manufacturing Method Therefore]

Next, a polycarbonate resin molded article of the present invention is described.

The polycarbonate resin molded article of the present invention is obtained by molding the above-mentioned polycarbonate resin composition of the present invention using an injection molding method or the like. Upon molding, the thickness of the polycarbonate molded article is preferably about 0.3 to 10 mm, and is appropriately selected from the range depending on an application of the molded article.

A method of producing the polycarbonate resin molded article of the present invention is not particularly limited, and any one of the various conventionally known molding methods such as an injection molding method, an injection compression molding method, an extrusion molding method, a blow molding method, a press molding method, a vacuum molding method, and a foam molding method can be employed; injection molding at a mold temperature of 120° C. or more, preferably 120° C. to 140° C. is preferred. In this case, a resin temperature in the injection molding is typically about 240 to 300° C., preferably 260 to 280° C.

Injection molding at a mold temperature of 120° C. or more, preferably 120° C. to 140° C. provides, for example, such merit that the molded article can provide a good appearance. The mold temperature is more preferably 125° C. or more and 140° C. or less, still more preferably 130° C. to 140° C. The PC resin composition of the present invention as a molding raw material is preferably pelletized by the melt-kneading method before being used. It should be noted that gas injection molding for the prevention of sink marks in the appearance of the molded article or for a reduction in weight of the molded article can be adopted as an injection molding method.

In the thus obtained polycarbonate resin molded article of the present invention, the occurrence of a weld line is reduced, and even when a weld line is formed, the difference in luminosity between the left and right sides of the weld line is not visually observed, and a good metallic appearance or a galactic appearance can be obtained on the entire surface of the molded article.

It should be noted that the difference in luminosity between the left and right sides of the weld line can be measured by a method involving: irradiating a test piece with daylight from an oblique angle of 45°; and visually observing the left and right sides of the weld line.

In addition, the present invention provides a method of producing a polycarbonate resin molded article characterized by including subjecting the above-mentioned polycarbonate resin composition of the present invention to injection molding at a mold temperature of 120° C. or more, preferably 120° C. to 140° C. to produce a molded article.

The polycarbonate resin molded article of the present invention is preferably used for the following items, for example:
(1) various parts of televisions, radio cassettes, video cameras, video tape recorders, audio players, DVD players, air conditioners, cellular phones, displays, computers, resistors, electric calculators, copiers, printers, and facsimiles, and electrical/electronic device parts such as outside plates and housing materials;
(2) parts for precision machinery such as cases and covers for precision machines such as PDA's, cameras, slide projectors, clocks, gauges, display instruments;
(3) parts for automobiles such as automobile interior materials, exterior products, and automobile body parts including instrument panels, upper garnishes, radiator grills, speaker grills, wheel covers, sunroofs, head lamp reflectors, door visors, spoilers, rear windows, and side windows; and
(4) parts for furniture such as chairs, tables, desks, blinds, lighting covers, and interior instruments.

### EXAMPLES

Hereinafter the present invention is described in more detail by way of examples and comparative examples, but the present invention is not limited thereto.

It should be noted that a polycarbonate resin composition pellet obtained in each of the following examples and comparative examples was subjected to injection molding with a 100-t injection molding machine (manufactured by TOSHIBA MACHINE CO., LTD, device name “IS100E”) at a mold temperature of 130° C. and a resin temperature of 280° C., whereby a test piece having a predetermined shape was produced. The test piece thus produced was evaluated for various characteristics as described below.

[Evaluation Test]

### (1) Metallic Feeling

The surface appearance of a test piece was visually observed, and was then evaluated for whether the appearance had a metallic feeling targeted by the present invention by the following three-stage criteria.

3: A metallic feeling is sufficient, 2: the appearance has a metallic feeling, 1: the appearance has no metallic feeling.

### (2) Weld Line

The surface appearance of a test piece was visually observed and evaluated for its weld black line by the following five-stage criteria.

5: No weld black line is visible, 4: nearly no weld black line is visible, 3: a weld black line is somewhat conspicuous, 2: a weld black line is conspicuous, 1: a weld black line is clearly visible.

### (3) Difference in Luminosity Between Left and Right Sides of Weld Line

The surface appearance of a test piece was visually observed and evaluated for its difference in luminosity between the left and right sides of a weld line by the following five-stage criteria.

5: No difference is visible, 4: nearly no difference is visible, 3: the difference is somewhat conspicuous, 2: the difference is conspicuous, 1: the difference is clearly visible.

[Resin Composition Component]

The respective components used for the production of a pellet of a polycarbonate resin composition are shown below.

### (Component (A))

Aromatic PC resin: a bisphenol A polycarbonate having a viscosity-average molecular weight of 17,000 (manufactured by Idemitsu Kosan Co., Ltd., trade name “TARFLON FN1700A”)

### (Component (B))

Titanium oxide: rutile type titanium oxide containing 95% of TiO₂ and having an average particle diameter of 0.21 μm (manufactured by ISHIHARA SANGYO KAISHA, LTD., trade name “CR60-2”)

### (Component (C))

(C-1) Glossy particles 1: titania-coated glass flakes having an average particle diameter of 40 μm (manufactured by NIPPON SHEET GLASS Co., Ltd., trade name “MC104ORS”)

(C-2) Glossy particles 2: silver-coated glass flakes having an average particle diameter of 90 μm (manufactured by NIPPON SHEET GLASS Co., Ltd., trade name “MC5090RS”)

### (Component (D))

Silicone particles: a polyorganosilsesquioxane cured product powder having an average particle diameter of 5.0 μm (manufactured by Shin-Etsu Chemical Co., Ltd., trade name “X-52-1621”)

### (Component (E))

Colorant (aluminum powder particles) : particles having an average particle diameter of 35 μm (manufactured by Nihonboshitsu Co., Ltd., trade name “NJ80”)

### Examples 1 to 12 and Comparative Examples 1 to 9

In each of the examples and the comparative examples, the respective components were mixed at a blending ratio shown in Tables 1 and 2, and the mixture was melted and kneaded with a twin-screw extruder (manufactured by TOSHIBA MACHINE CO., LTD., device name “TEM-35B”) at 280° C., whereby a polycarbonate resin composition pellet was produced. The above-mentioned evaluation test was performed using each pellet. Tables 1 and 2 show the results all together.

TABLE 1

| | | | Exam- | Comparative | Exam- | Comparative | Exam- | Exam- | Exam- | Exam- | Comparative |
|---|---|---|---|---|---|---|---|---|---|---|---|
| | | | ple 1 | Example 1 | ple 2 | Example 2 | ple 3 | ple 4 | ple 5 | ple 6 | Example 3 |
| Composition | (A) | Aromatic PC resin (part(s)) | 100 | 100 | 100 | 100 | 100 | 100 | 100 | 100 | 100 |
| | (B) | Titanium oxide | 0.1 | — | 0.1 | — | 0.1 | 0.1 | 0.1 | 0.2 | 0.4 |
| | | Average particle diameter | | | | | | | | | |
| | | 0.21 μm (part(s)) | | | | | | | | | |
| | (C) | (C-1) Glossy particle 1 | 0.1 | 0.1 | 0.1 | 0.1 | 0.1 | 0.1 | 0.1 | 0.1 | 0.1 |
| | | Average particle diameter | | | | | | | | | |
| | | 40 μm (part(s)) | | | | | | | | | |
| | | (C-2) Glossy particle 2 | 0.1 | 0.1 | 0.1 | 0.1 | 0.1 | 0.1 | 0.1 | 0.1 | 0.1 |
| | | Average particle diameter | | | | | | | | | |
| | | 90 μm (part(s)) | | | | | | | | | |
| | (D) | Silicone particles (part(s)) | — | 0.1 | — | 0.1 | 0.1 | 0.1 | 0.3 | 0.1 | 0.1 |
| | (E) | Colorant | — | — | 0.1 | 0.1 | — | 0.1 | 0.1 | 0.1 | 0.1 |
| | | Aluminum powder particles | | | | | | | | | |
| | | (part(s)) | | | | | | | | | |

| | | | | | | | | | | |
|---|---|---|---|---|---|---|---|---|---|---|
| Evaluation | Metallic feeling | 2 | 3 | 2 | 3 | 2 | 2 | 2 | 2 | 1 |
| | Weld line | 5 | 2 | 3 | 1 | 4 | 5 | 5 | 4 | 5 |
| | Difference in luminosity between | 5 | 5 | 4 | 5 | 5 | 5 | 4 | 5 | 5 |
| | left and right sides of weld line | | | | | | | | | |

TABLE 2

| | | | Example | | | | | | Comparative Example | | | | | |
|---|---|---|---|---|---|---|---|---|---|---|---|---|---|---|
| | | | 7 | 8 | 9 | 10 | 11 | 12 | 4 | 5 | 6 | 7 | 8 | 9 |
| Composition | (A) | Aromatic PC resin (part(s)) | 100 | 100 | 100 | 100 | 100 | 100 | 100 | 100 | 100 | 100 | 100 | 100 |
| | (B) | Titanium oxide | 0.1 | 0.1 | 0.1 | 0.1 | 0.1 | 0.1 | 0.01 | 1 | 0.1 | 0.1 | 0.1 | 0.1 |
| | | Average particle diameter | | | | | | | | | | | | |
| | | 0.21 μm (part(s)) | | | | | | | | | | | | |
| | (C) | (C-1) Glossy particle 1 | 0.01 | 0.5 | 0.1 | 0.1 | 0.1 | 0.1 | 0.1 | 0.1 | 2 | 0.1 | 0.1 | — |
| | | Average particle diameter | | | | | | | | | | | | |
| | | 40 μm (part(s)) | | | | | | | | | | | | |
| | | (C-2) Glossy particle 2 | 0.1 | 0.1 | 0.01 | 2 | 0.1 | 0.1 | 0.1 | 0.1 | 0.1 | 3 | — | 0.1 |
| | | Average particle diameter | | | | | | | | | | | | |
| | | 90 μm (part(s)) | | | | | | | | | | | | |
| | (D) | Silicone particles (part(s)) | 0.1 | 0.1 | 0.1 | 0.1 | 0.1 | 0.01 | 0.1 | 0.1 | 0.1 | 0.1 | 0.1 | 0.1 |
| | (E) | Colorant | 0.1 | 0.1 | 0.1 | 0.1 | 0.01 | 0.1 | 0.1 | 0.1 | 0.1 | 0.1 | 0.1 | 0.1 |
| | | Aluminum powder particles | | | | | | | | | | | | |
| | | (part(s)) | | | | | | | | | | | | |

| | | | | | | | | | | | | | |
|---|---|---|---|---|---|---|---|---|---|---|---|---|---|
| Evaluation | Metallic feeling | 2 | 2 | 2 | 3 | 2 | 2 | 3 | 1 | 3 | 3 | 2 | 2 |
| | Weld line | 3 | 3 | 4 | 5 | 4 | 3 | 1 | 5 | 3 | 4 | 4 | 3 |
| | Difference in luminosity between | 4 | 4 | 3 | 3 | 3 | 3 | 4 | 5 | 1 | 2 | 4 | 2 |
| | left and right sides of weld line | | | | | | | | | | | | |

### INDUSTRIAL APPLICABILITY

The polycarbonate resin composition of the present invention has excellent heat resistance and an excellent mechanical strength. While a resin molded article using the resin composition maintains the properties, the occurrence of a weld line is reduced in the molded article. Even when the weld line is formed, no difference in luminosity between the left and right sides thereof is visible, and hence a good metallic or galactic appearance is obtained on the entire surface of the molded article. Accordingly, the composition suitably finds use in applications in a structural member field where a design appearance is requested such as a television, a refrigerator, or a cleaner.

1. A polycarbonate resin composition, comprising:
(A) 100 parts by mass of an aromatic polycarbonate resin;
(B) 0.05 to 0.3 part by mass of titanium oxide having an average particle diameter of 0.05 to 6 μm; and
(C)
(C-1) 0.005 to 1 part by mass of glossy particles having an average particle diameter of 10 μm or more and less than 60 μm, and
(C-2) 0.005 to 2.5 parts by mass of glossy particles having an average particle diameter of 60 to 300 μm.

2. The polycarbonate resin composition according to claim 1, further comprising:
(D) 0.05 to 0.5 part by mass of silicone particles having an average particle diameter of 0.05 to 6 μm with respect to 100 parts by mass of the aromatic polycarbonate resin (A).

3. The polycarbonate resin composition according to claim 1, wherein the glossy particles (C) comprise at least one selected from the group consisting of mica, metal particles, metal sulfide particles, particles having a surface coated with a metal or a metal oxide, and glass flakes having a surface coated with a metal or a metal oxide.

4. The polycarbonate resin composition according to claim 1, further comprising:
(E) 0.0001 to 0.3 part by mass of a colorant with respect to 100 parts by mass of the aromatic polycarbonate resin (A).

5. The polycarbonate resin composition according to claim 4, wherein the colorant as (E) comprises aluminum powder particles.

6. The polycarbonate resin composition according to claim 5, wherein the aluminum powder particles have an average particle diameter of 30 to 80 μm.

7. A polycarbonate resin molded article obtained by molding the polycarbonate resin composition according to claim 1.

8. The polycarbonate resin molded article according to claim 7, wherein the polycarbonate resin molded article is obtained by injection molding at a mold temperature of 120° C. or more.

9. A method of producing a polycarbonate resin molded article, the method comprising injection molding the polycarbonate resin composition according to claim 1 at a mold temperature of 120° C. or more.

10. The polycarbonate resin composition according to claim 2, wherein the glossy particles (C) comprise at least one selected from the group consisting of mica, metal particles, metal sulfide particles, particles having a surface coated with a metal or a metal oxide, and glass flakes having a surface coated with a metal or a metal oxide.

11. The polycarbonate resin composition according to claim 2, further comprising:
(E) 0.0001 to 0.3 part by mass of a colorant with respect to 100 parts by mass of the aromatic polycarbonate resin (A).

12. The polycarbonate resin composition according to claim 11, wherein the colorant as (E) comprises aluminum powder particles.

13. The polycarbonate resin composition according to claim 12, wherein the aluminum powder particles have an average particle diameter of 30 to 80 μm.

14. A polycarbonate resin molded article obtained by molding the polycarbonate resin composition according to claim 2.

15. The polycarbonate resin molded article according to claim 14, wherein the polycarbonate resin molded article is obtained by injection molding at a mold temperature of 120° C. or more.

16. A method of producing a polycarbonate resin molded article, the method comprising injection molding the polycarbonate resin composition according to claim 2 at a mold temperature of 120° C. or more.
